(19) United States
(12) Patent Application Publication
(10) Pub. No.: US 2015/0197172 A1
(43) Pub. Date: Jul. 16, 2015

(54) SEAT PROTECTION SYSTEM

(71) Applicant: James R. DURNIL, Austin, TX (US)

(72) Inventor: James R. DURNIL, Austin, TX (US)

(21) Appl. No.: 14/592,778

(22) Filed: Jan. 8, 2015

Related U.S. Application Data
(60) Provisional application No. 61/926,692, filed on Jan. 13, 2014.

(51) Int. Cl. B60N 2/60

(52) U.S. Cl. CPC B60N 2/6009

(57) ABSTRACT

A seat protection system having a protective barrier that is placed on exposed surfaces of seats or chairs. The seat protection system is designed to adapt to contours of a different types of seats or chairs without bunching or slippage. The seat protection system is preferably made of a material that is odor resistant and resistant to rips, tears, scrapes or other damage. The seat protection system is designed to be removable and reusable with a minimal amount of effort to permit washing and easy product maintenance.

### FIELD

The present disclosure relates to a seat protection system including a shield or cover for a seat for use in an application in which the seat would otherwise be exposed to possible contamination or other damage.

### BACKGROUND

Conventional seating is subject to contamination which can result in staining and other damage. For example, a driver seat in an automobile can be exposed to perspiration if the driver sits in it after exercising but before having an opportunity to shower and put on fresh clothing. It is difficult to prevent such damage without using measures which are often so inconvenient that they fall into disuse.

There is thus a need for seat protection system which is effective at protecting the seat while at the same time being sufficiently easy to install and maintain that the user will not be discouraged from employing it.

### SUMMARY

The following presents a simplified summary of one or more embodiments in order to provide a basic understanding of the embodiments. This summary is not an extensive overview of all contemplated embodiments, and is not intended to identify key or critical elements of all embodiments nor delineate the scope of any or all embodiments. Its sole purpose is to present some concepts of one or more embodiments in a simplified form as a prelude to the more detailed description that is presented later.

According to one aspect of the present invention, a seat shield or cover is constructed of different technical fabric materials that provide protection from foreign elements that could permanently damage seats or chairs. The seat protection system is preferably removable and reusable. It can be specifically designed for use in passenger vehicles, on home furniture, or on portable seating.

According to another aspect of the invention, there is provided a seat protection system comprising a front panel having a top edge, a bottom edge and first and second lateral edges and made of a dimensionally stable fabric and a rear panel having a top edge, a bottom edge and first and second lateral edges and made of a dimensionally stable fabric, the top edge of the rear panel being connected to the top edge of the front panel. The seat protection system also includes a first side panel connecting at least an upper portion of the front panel first lateral edge with the rear panel first lateral edge, the first side panel being made of a stretchable material and a second side panel connecting at least an upper portion of the front panel second lateral edge with the rear panel second lateral edge, the second side panel being made of a stretchable material, the rear panel, first side panel, second side panel and at least a portion of the front panel together forming a pocket dimensioned to receive an upper portion of a backrest of a seat. The protection system further includes a base panel attached to the bottom edge of the front panel and configured and dimensioned to substantially cover an upper surface of a base of the seat.

The front panel and the base panel may be made of a fabric having odor resistant properties. The seat protection system may also include a handle attached to an upper portion of the front panel to facilitate removal of the seat protection system from a seat.

According to another aspect of the invention, the front panel and the base panel are dimensioned to cover substantially all of a front and bottom surface of the seat. A bottom surface of the base panel may include an elastomeric material that reduces relative movement the bottom surface of the base panel with respect to an upper surface of the seat base. The elastomeric material may be, for example, a rubber material or a silicone material. The front panel and the rear panel may include a material adapted to withstand repeated washing.

### BRIEF DESCRIPTION OF THE DRAWING

FIG. 1 is a perspective view of one embodiment of a seat protection system according to the present invention;

FIG. 2 is a perspective view of the embodiment of FIG. 1 with the seat protection system partially lifted to show a bottom surface of the shield;

FIG. 3 is a perspective view of the embodiment of FIG. 1 with the side of the protection system more clearly visible; and

FIG. 4 is a perspective view of the embodiment of FIG. 1 with the rear portion of the protection system more clearly visible.

### DETAILED DESCRIPTION

Various embodiments are now described with reference to the drawings, wherein like reference numerals are used to refer to like elements throughout. In the following description, for purposes of explanation, numerous specific details are set forth in order to promote a thorough understanding of one or more embodiments. It may be evident in some or all instances, however, that any embodiment described below can be practiced without adopting the specific design details described below.

The following presents a simplified summary of one or more embodiments in order to provide a basic understanding of the embodiments. This summary is not an extensive overview of all contemplated embodiments, and is not intended to identify key or critical elements of all embodiments nor delineate the scope of any or all embodiments.

The seat protection system is preferably composed of technical fabrics and constructed in a way that protects a seat or a chair from foreign elements that could permanently damage it. As used here, a “technical fabric” or a “technical textile” is a textile product manufactured for utilitarian rather than aesthetic purposes. The seat protection system is preferably a removable, reusable protective barrier that is placed on seats or chairs to prevent damage by liquids, bodily fluids, sand, chemicals, plant matter, and other outdoor elements, as well as provide protection from rips, tears, scrapes or other damage caused by placing items such as boxes, athletic equipment, car seats, tools, bags, or other items that have sharp edges or blunt sides that may cause damage to seats.

The seat protection system is preferably designed to conform to the contours of a seat or chair without bunching or slippage. The seat protection system is preferably made of an odor resistant material that will protect the seat from elements that could otherwise permeate the seat material. These elements could include but not be limited to bodily fluids, liquids, chemicals, or other outdoor elements.

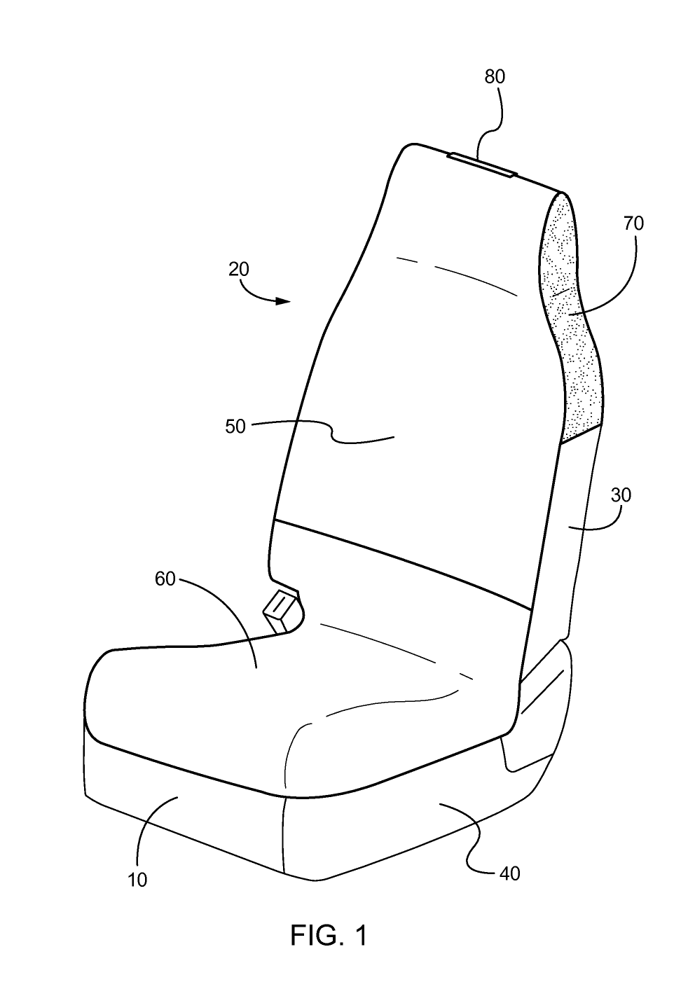

Referring now to FIG. 1 there is shown a vehicle seat 10 with the seat protection system 20 covering the front of a backrest 30 and top surface of a seat base 40. The backrest 30 may or may not include a headrest (not shown). FIG. 1 and the following description describes the use of the seat protection system on a vehicle seat as a specific example, but one of ordinary skill in the art will readily appreciate that the teaching of the invention are equally applicable to other types of seats as well.

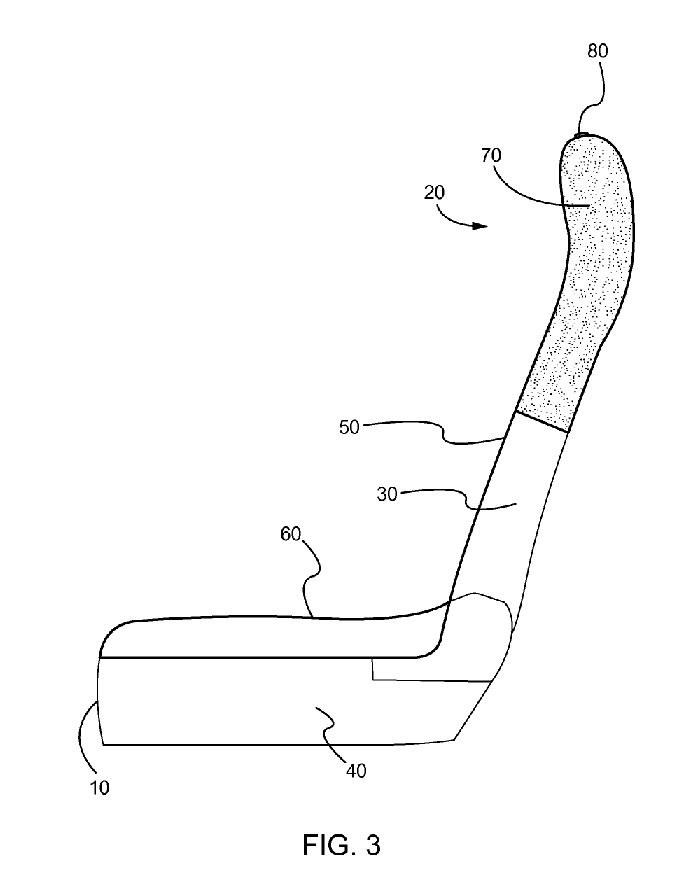

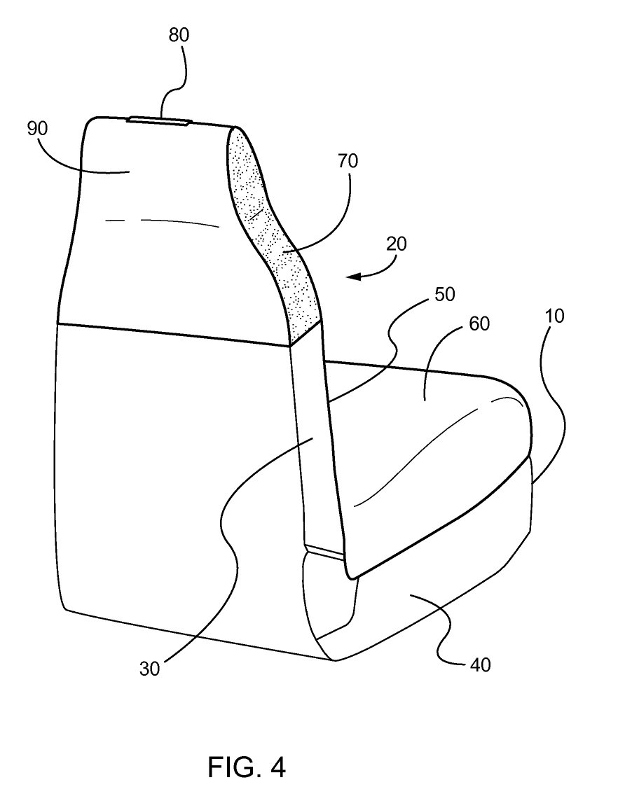

Specifically, FIG. 1 also shows the seat protection system 20 includes a front panel 50 covering a front surface of backrest 30 and a base panel 60 covering a top surface of the seat base 40. Front panel 50 is preferably made of a dimensionally stable material, that is, a material that does not stretch substantially or otherwise deform substantially under tension. The seat protection system 20 also includes side panels 70, one on each side with the side panel 70 on the driver's left visible in FIGS. 1-4. The side panel 70 to the driver's right is preferably a mirror image of the side panel 70 to the driver's left. The left and right side panels 70 are preferably made of a stretchable material, that is, a material that stretches, i.e., undergoes elastic deformation under tension. The side panels 70 are preferably made of a durable elastic material such as spandex allowing the seat cover 20 to be used on seats of different sizes. Thus the left and right side panels 70 stretch to firmly secure the seat protection system 20 to the seat 10. The seat protection system 20 also preferably includes a handle 80 to facilitate removal of the seat protection system 20. As shown in FIGS. 3 and 4, the handle 80 is preferably positioned at the top of the backrest 30.

As shown in FIG. 4, the seat protection system 20 also includes a rear panel 90 covering an upper portion of the rear of the backrest 30. Rear panel 90 is preferably made of a dimensionally stable material, that is, a material that does not stretch substantially or otherwise deform substantially under tension. As can be seen, the rear panel 90 preferably extends between about a quarter way to about half way down the back of the seat 10. The left and right side panels 70 also preferably extends down the sides of the seat 10 substantially the same amount to as the rear panel 90 extends down the back of the seat 10. In this way, a portion of the front panel 50, left and right side panels 70, and the rear panel 90 form a pocket-like structure which accommodates the top portion of the seat 10. Because the left and right side panels 70 are preferably made of a stretchable material, this enables the seat protection system 20 to be securely attached to it to substantially conform to seats of a variety of sizes and configurations.

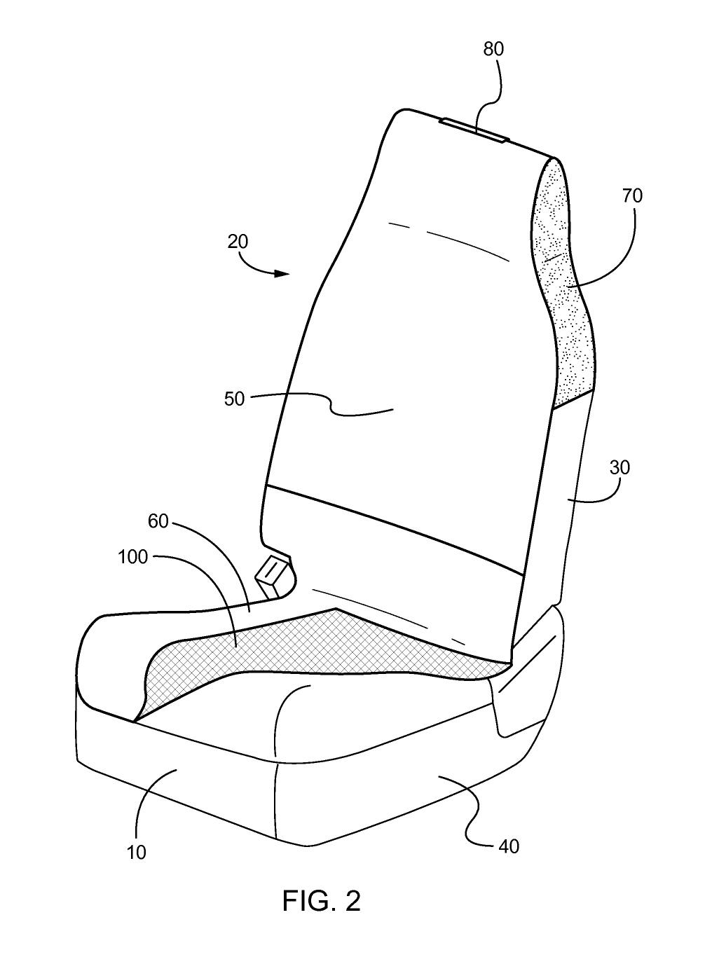

As shown in FIG. 2, base panel 60 is attached to a lower edge of the front panel 50 at a location at or near where the backrest 30 abuts the seat base 40. The base panel 60 rests atop an upper surface of the seat base 40. The underside of the base panel 60 is preferably provided with a non-slip surface 100 designed to reduce or prevent slipping or sliding motion of the base panel 60 with respect to the upper surface of the seat base 40. This non-slip surface may be a fabric or a surface treatment such as a linear, sinuous, or dotted bead of an elastomeric material such as silicone. In a presently preferred embodiment, the non-slip fabric is preferably a technical fabric which prevents the growth of odor causing bacteria within the material that has a silicone or other rubber application on the surface that comes into contact with the seat base 40.

The seat protection system 20 is preferably constructed of materials that will allow it to be machine washable to maintain cleanliness and permit repeated use. In a presently preferred embodiment, the material for the front panel 50, base panel 60, and rear panel 90 is preferably a technical fabric which prevents the growth of odor causing bacteria within the material.

As shown in FIG. 4, the seat protection system 20 fits to the backrest 30 of the seat 10 to ensure the seat protection system 20 stays in place while in use. The side panel 70 provides the flexibility to fit different seat types and keep the seat protection system 20 in place during use. FIG. 4 also shows the handle 80 at the top of the seat protection system 20 to facilitate removal of the seat protection system 20.

In more detail, referring again to FIG. 1 the seat protection system 20 is placed over the top of the seat 10. The front panel 50 preferably conforms to the front surface of the backrest 30 in the area which comes into contact with a user's back. The seat protection system 20 is held in place by the structure formed by the cooperation of the front panel 50, side panels 70, and rear panel 90 which together form a pocket-like structure that fits over and receives the backrest 30. Preferably the pocket extends a distance between about the quarter way and about midway down the backrest 30. The side panels 70 ensure the seat protection system does not move but also allow for use with different types and sizes of seats. The handle 80 at the top allows for quick removal and use across different seats.

In further detail, referring to FIG. 1, the seat protection system 20 preferably measures approximately 60″ to approximately 70″ in length from bottom edge of the base panel 60 to the handle 80, with the front panel 50, base panel 60, and rear panel 90 preferably being approximately 24″ to approximately 26″ in width. As shown, the front panel 50 and rear panel 90 may be tapered towards the top to accommodate a headrest if present. These dimensions provide sufficient latitude to ensure the coverage of the entire seat base 40 where a user would sit and a large enough pocket to ensure the seat protection system 20 can snugly accommodate backrests 30 of varying sizes and configurations.

The front panel 50 and rear panel 90 may be made of a durable fabric having dimensional stability while side panels 70 may be made of a stretchable fabric. The handle 80 may be made of nylon or a similar fabric. The base panel 60 is preferably made of a water-resistant non-slip fabric or a water resistant fabric with a non-slip fabric or non-slip treatment applied to the side which confronts the top surface of the seat base 40. It will be apparent to one of ordinary skill in the art that other materials may be used.

The materials are preferably chosen so that the seat protection system 20 can act as a barrier between a user's body and the seat or chair in use, to prevent damage to the seat's materials such as leather or expensive vinyl, prevention of permeation of odor or other damage that may be caused by liquids, bodily fluids, sand, chemicals, trees/branches, and other outdoor elements to seats, and protection from rips, tears, scrapes or other damage caused by placing items such as boxes, athletic equipment, children car seats, tools, bags, or other items that have sharp edges or blunt sides that may cause damage to seats.

The base panel 60 may also be made of a water absorbent fabric with a non-slip fabric or non-slip treatment applied to the side which confronts the top surface of the seat base 40. Such materials if they are sufficiently absorbent can still act as a barrier between a user's body and the seat or chair in use.

The seat protection system 20 is constructed, configured and dimensioned to slide onto a seat and remain in place during use, without excessive slippage between the seat protection system and the surfaces of the seat it is protecting. At the same time, the seat protection system 20 is constructed, configured and dimensioned to be easily removed so it may be cleaned and re-used.

The above description includes examples of multiple embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is construed when employed as a transitional word in a claim. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A seat protection system comprising:
a front panel having a top edge, a bottom edge and first and second lateral edges and made of a dimensionally stable fabric;
a rear panel having a top edge, a bottom edge and first and second lateral edges and made of a dimensionally stable fabric, the top edge of the rear panel being connected to the top edge of the front panel;
a first side panel connecting at least an upper portion of the front panel first lateral edge with the rear panel first lateral edge, the first side panel being made of a stretchable material;
a second side panel connecting at least an upper portion of the front panel second lateral edge with the rear panel second lateral edge, the second side panel being made of a stretchable material, the rear panel, first side panel, second side panel and at least a portion of the front panel together forming a pocket dimensioned to receive an upper portion of a backrest of a seat; and
a base panel attached to the bottom edge of the front panel and configured and dimensioned to substantially cover an upper surface of a base of the seat.

2. A seat protection system as claimed in claim 1 wherein the front panel and the base panel are made of a fabric having odor resistant properties.

3. A seat protection system as claimed in claim 1 further comprising a handle attached to an upper portion of the front panel to facilitate removal of the seat protection system from a seat.

4. A seat protection system as claimed in claim 1 wherein the front panel and the base panel are dimensioned to cover substantially all of a front and bottom surface of the seat.

5. A seat protection system as claimed in claim 1 wherein a bottom surface of the base panel comprises an elastomeric material that reduces relative movement the bottom surface of the base panel with respect to an upper surface of the seat base.

6. A seat protection system as claimed in claim 5 wherein the elastomeric material comprises a rubber material.

7. A seat protection system as claimed in claim 5 wherein the elastomeric material comprises a silicone material.

8. A seat protection system as claimed in claim 1 wherein the front panel and the rear panel comprise a material adapted to withstand repeated washing.

9. A seat protection system comprising:
a front panel having a top edge, a bottom edge and first and second lateral edges and made of a dimensionally stable fabric having odor resistant properties;
a rear panel having a top edge, a bottom edge and first and second lateral edges and made of a dimensionally stable fabric, the top edge of the rear panel being connected to the top edge of the front panel having odor resistant properties;
a first side panel connecting at least an upper portion of the front panel first lateral edge with the rear panel first lateral edge, the first side panel being made of a stretchable material;
a second side panel connecting at least an upper portion of the front panel second lateral edge with the rear panel second lateral edge, the second side panel being made of a stretchable material, the rear panel, first side panel, second side panel and at least a portion of the front panel together forming a pocket dimensioned to receive an upper portion of a backrest of a seat;
a base panel attached to the bottom edge of the front panel and configured and dimensioned to substantially cover an upper surface of a base of the seat, the front panel and the base panel being dimensioned to cover substantially all of a front and bottom surface of the seat and a bottom surface of the base panel comprising an elastomeric material that reduces relative movement the bottom surface of the base panel with respect to an upper surface of the seat base; and
a handle attached to an upper portion of the front panel to facilitate removal of the seat protection system from a seat.

10. A seat protection system as claimed in claim 9 wherein the elastomeric material comprises a rubber material.

11. A seat protection system as claimed in claim 9 wherein the elastomeric material comprises a silicone material.

12. A seat protection system as claimed in claim 9 wherein the front panel and the rear panel comprise a material adapted to withstand repeated washing.
